(19) United States
(12) Patent Application Publication
(10) Pub. No.: US 2014/0045550 A1
(43) Pub. Date: Feb. 13, 2014

(54) Utility Node Communication Device Adaptable to a Cellular Device

(71) Applicant: Itron, Inc., Liberty Lake, WA (US)

(72) Inventors: Andrew Leon Rosenberg, Otis Orchards, WA (US); Gabriel Achenbach, Spokane, WA (US)

(21) Appl. No.: 13/927,448

(22) Filed: Jun. 26, 2013

Related U.S. Application Data
(60) Provisional application No. 61/681,492, filed on Aug. 9, 2012.

(51) Int. Cl. G01D 4/00

(52) U.S. Cl. CPC G01D 4/002
USPC 455/557

(57) ABSTRACT

Techniques and devices for communicating with a utility node device through a utility node communication device and utilizing resources of a cellular device are described herein. The utility node communication device may connect to and/or release the cellular device (e.g., cellular telephone) providing an enclosure for the cellular device. The utility node communication device may communicate with the utility node device (e.g., a smart utility meter) and utilize a cellular radio of the cellular device to communicate with a head end device of a utility. The utility node communication device may also utilize a processor, memory, display, or operating system of the cellular device.

### CROSS REFERENCE TO RELATED APPLICATIONS

This application claims the benefit of U.S. Provisional Application No. 61/681,492, filed Aug. 9, 2012, which is incorporated herein by reference.

### BACKGROUND

Many utilities use handheld devices to read, configure, service, and install utility meters. These handheld devices often communicate with the utility meters over radio frequencies and/or power levels that require the handheld devices to be relatively close to the meters (e.g., within a few hundred feet). In some instances, the meters are configured for automatic meter reading (AMR).

These handheld devices are generally designed specifically for the utility environment (e.g., meter reading, configuring, servicing, and installing). For example, a handheld device may include a particular radio that can communicate with a meter, a particular input/output device (e.g., specialized ports for connecting to meters), and/or particular software/hardware computing capabilities (e.g., one or more communication protocols). Further, these components and other components must meet ruggedized standards in order to satisfy the day-to-day use of the handheld device in the field. Due to these design parameters and a relatively low manufacturing volume, the handheld devices are relatively expensive to design and manufacture per unit in comparison to other computing devices, such as personal computers and cellular telephones. In addition, these handheld devices may lack the processing capabilities that are common in other computing devices.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example utility node communication device adapted to receive and/or release a cellular device.

FIG. 2 illustrates an example of the utility communication device of FIG. 1 with a dock detached from a main body of the communications device.

FIG. 3A illustrates an example of a side view of the utility communication device illustrated in FIG. 1.

FIG. 3B illustrates an example of a front view of the utility communication device illustrated in FIG. 1.

FIG. 4 illustrates an example of a back view of the utility communication device illustrated in FIG. 1.

FIG. 5 illustrates an example of an interior of the utility communication device illustrated in FIG. 1.

FIG. 6A illustrates an example of a perspective view of the dock of the utility communication device illustrated in FIG. 1.

FIG. 6B illustrates a cross-sectional view of the dock taken through the 6B-6B lines of the dock illustrated in FIG. 6A.

FIG. 6C illustrates a cross-sectional view of the dock taken through the 6C-6C lines of the dock in FIG. 6A.

FIG. 7 illustrates an example of a dock that may be attached to the main body illustrated in FIG. 1, in this instance receiving a cell phone that is inserted into the dock.

FIG. 8 illustrates an example utility communication device communicatively coupled to a cellular device that is not received (e.g., by a dock) in the utility communication device.

FIG. 9 illustrates an example process to receive utility information from one or more utility node devices, send the utility information to a cellular device, and perform an action at the cellular device.

### DETAILED DESCRIPTION

### Overview

As discussed above, handheld devices are utilized by utilities (e.g., water, gas, and/or electric companies) to read, configure, service, and install utility meters. These devices are often designed specifically for the utility environment, which up to this point has required a substantial amount of time and money to design and manufacture. Because these handheld devices are usually produced in low volume, the handheld devices are relatively expensive in comparison to other computing devices, such as personal computers and cellular telephones, which are produced in high volume. Further, these handheld devices may lack the processing capabilities that are common in other computing devices.

This disclosure is directed to techniques and devices for communicating with a utility node device (e.g., smart utility meter, sensor, etc.) through a utility node communication device and utilizing resources of a cellular device (e.g., cellular telephone, etc.) communicatively coupled to the utility node communication device. In some instances, the utility node communication device provides a ruggedized enclosure and communication resources to communicate with the utility node device, while utilizing resources of the cellular device (e.g., a cell phone), such as a processor, memory, display, operating system, and/or cellular radio.

In particular implementations, a utility node communication device may comprise an enclosure that includes a radio to communicate with a utility node device, such as a smart utility meter, a sensor, a control device, a relay, a transformer, etc. The enclosure may also include a communication component (e.g., a Bluetooth® module, a wired connection, etc.) to communicate with a cellular device communicatively coupled to the communication component. The cellular device may comprise a cellular telephone, personal digital assistant, a tablet computer, and so on.

In some instances, the utility node communication device also comprises a dock attached to the enclosure. The dock may removably receive and/or release the cellular device and/or provide a protective casing for the cellular device. The enclosure and the dock may be monolithically constructed or may be constructed to allow the dock to be removed and/or interchanged. In some instances, the dock includes a connection or adapter that may be interchanged to adapt to different types of cellular device connections. In other example implementations, the utility node communication device may not include a dock and the cellular device may be located proximate to the utility node communication device (e.g., located on an individual, in a same room, etc.) so that the utility communication device and the cellular device may communicate wirelessly.

Further, in some instances the utility node communication device comprises other components that may be useful in the field and/or in the utility environment. For example, the utility node communication device may include a specialized keyboard (e.g., keyboard with large, ruggedized, and/or customized buttons), a battery, a specialized port to connect with a utility node (e.g., meter probe port, such as a Hirose port or other data port), and so on. Additionally, or alternatively, the utility communication device may include shock absorbent protectors disposed at corners of the utility communication device to protect the cellular device and/or components of the utility communication device. As such, in some instances the utility node communication device may satisfy particular ruggedized standards for field use and/or the utility environment. For example, the utility communication device may be useable by an individual in the field to read, configure, service, and/or install utility node devices (e.g., “walk-by” meter reading, etc.), which may be configured for automatic meter reading (AMR).

In one example of operation, the utility node communication device receives utility information from a utility node device. The information is relayed to the cellular device communicatively coupled to the utility node communication device. The cellular device may perform one of various actions, such as displaying the utility information, processing the utility information, storing the utility information, sending the utility information to a head end device (e.g., central office of utility), and so on.

The utility node communication devices and techniques described herein may allow the resources (e.g., computing, communication, storage, etc.) of a cellular device to be utilized and provide other resources that are beneficial to field use and/or the utility environment. For example, the utility node communication device may leverage the processor, memory, display, operating system, cellular radio, and/or other resources of the cellular device, while providing other resources, such as a radio to communicate with a utility node, a specialized keyboard, and/or a ruggedized enclosure. By avoiding expenses associated with designing, manufacturing, and/or including components that may already be available on many cellular devices, overall design and manufacturing costs of the utility node communication device may be reduced. Further, this may allow the utility node communication device to leverage high volume manufacturing and/or high computing capabilities associated with many cellular devices (e.g., cellular telephones).

This brief introduction is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Example Utility Node Communication Devices

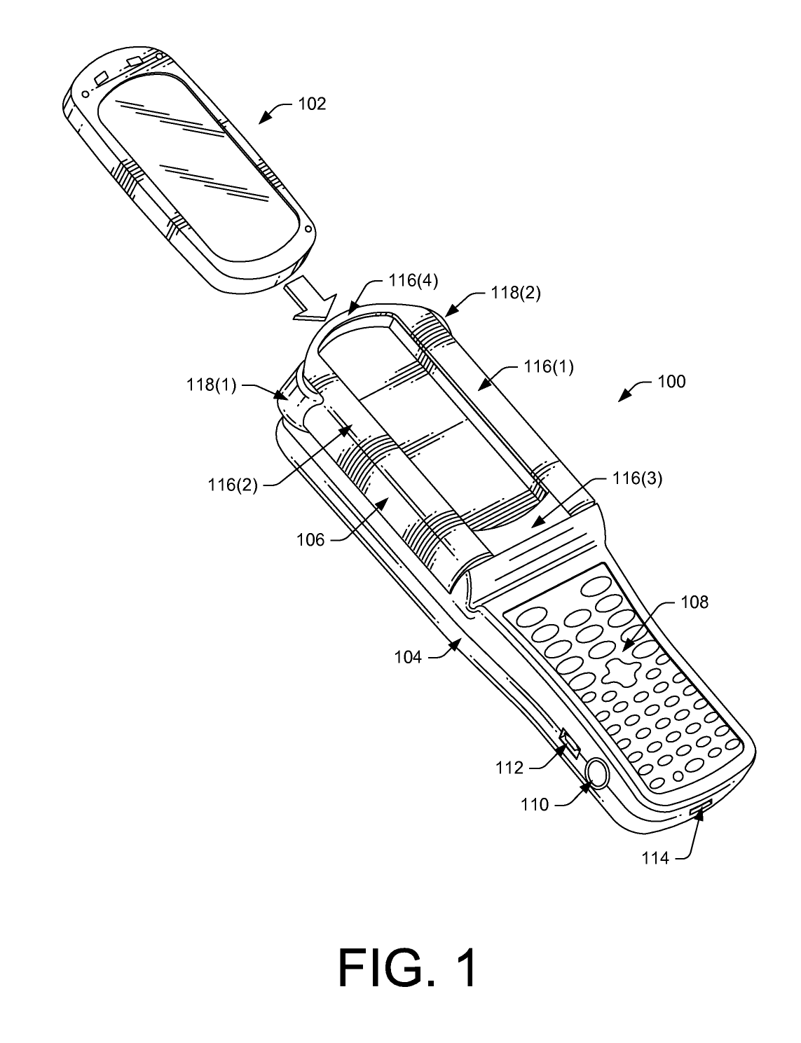

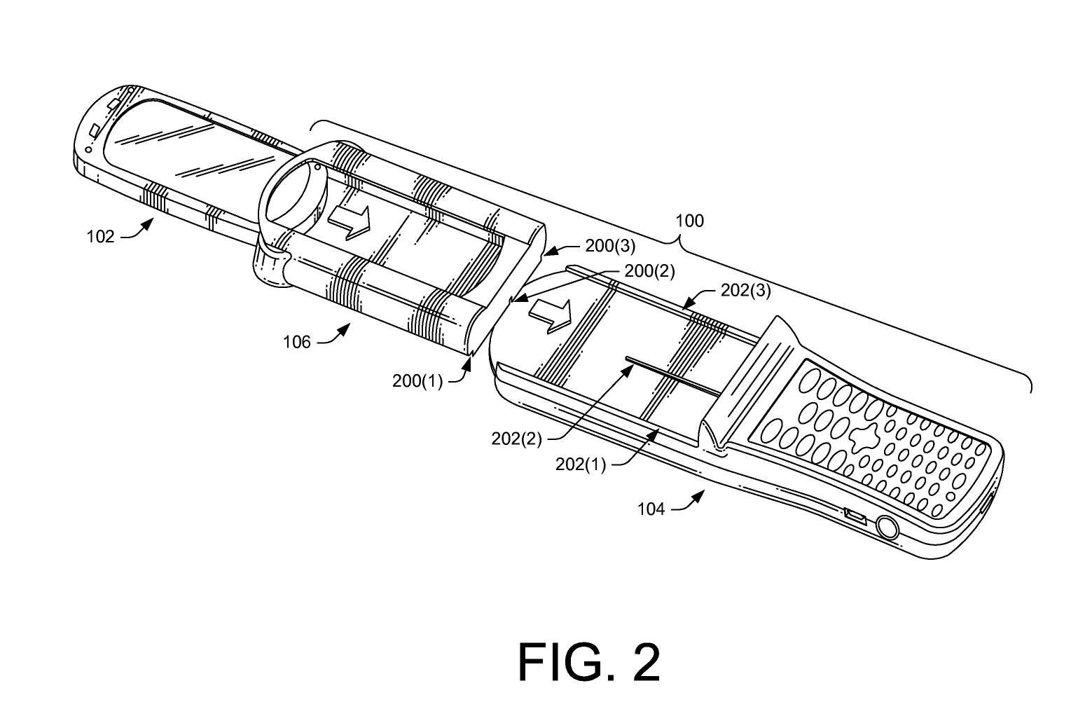

FIG. 1 illustrates an example utility node utility communication device 100 (hereinafter utility communication device 100) adapted to removably receive and/or release a cellular device 102. As such, the utility communication device 100 may be located proximately to the cellular device 102. In some instances, the utility communication device 100 includes components that are beneficial to field use and/or the utility environment without including components that are provided on the cellular device 102, such as a processor, memory, operating system, etc. The utility communication device 100 may include a main body 104 and a dock 106 (e.g., receptacle) attached to the main body 104. In some instances, the main body 104 and the dock 106 are a single piece, while in other instances the dock 106 is removably attached to the main body 104 (as illustrated in FIG. 2).

The main body 104 may include a communication component to communicate with the cellular device 102. The communication component may generally relay information (e.g., utility information, input/output information, etc.) between the components of the main body 104 and the cellular device 102. The communication component may be disposed in an interior of the main body 104 and may provide a wireless and/or wired connection to the cellular device 102. For example, the communication component may include a Bluetooth® module/radio or another module/radio configured to the communication capabilities of the cellular device 102. Alternatively, or additionally, the communication component may include electrical wiring and/or connections to communicate with the cellular device 102.

The main body 104 may also include a radio to communicate with a utility node device. The radio may be communicatively coupled to the communication component of the cellular device 102. The radio may generally comprise a receiver, transmitter, or transceiver configured to the communication capabilities of one or more utility node devices. In some instances, the radio communicates according to a particular standard or protocol, such as standards defined by the Institute of Electrical and Electronics Engineering (IEEE) (e.g., 802.11, 802.15, etc.), the Zigbee® standard, a customized standard, and so on. In one example, the radio is configured for automatic meter reading (AMR), such as an SRead™ radio. The radio may communicate with a utility node device according to a different standard, protocol, modulation technique, power level, and/or at a different frequency (e.g., protocol adapted for utility reading) than that utilized by the cellular device 102.

A utility node device may be configured as and/or disposed at a smart utility meter (e.g., electric, gas, and/or water meter), a sensor, a control device, a server, a relay (e.g., cellular relay), a router, a transformer, a repeater (e.g., configured to relay data), a switch, a valve, or another network device. Utility node devices may form a network in which nodes communicate over a common communication channel. The common communication channel may utilize a radio frequency (RF) or a wired medium. A wired medium may include dedicated wiring, or may include power line communication (PLC), i.e., a data signal superimposed over an alternating current (AC) power distribution line. In some instances, the nodes are configured as an advanced metering infrastructure (AMI) for automatic meter reading (AMR).

In the example utility communication device 100 of FIG. 1, the main body 104 includes a keyboard 108. The keyboard 108 may be customized to include buttons that are larger and/or more ruggedized than buttons on the cellular device 102. For example, the buttons may be water repellant/proof, larger in area, more raised, made of stronger materials, and so on. Further, the keyboard 108 may include customized buttons that implement functionality specific to the utility environment, such as buttons designed for reading, configuring, servicing, and/or installing meters. The keyboard 108 may receive input from an individual and send keystroke information based on the input to a radio and/or communication component of the main body 104. The keystroke information may comprise data to instruct the radio and/or communication component to perform an operation, data associated with a particular character (e.g., letter), and so on. In some instances, the keyboard 108 provides various benefits for field use and/or the utility environment that may not be provided by the cellular device 102. Although the example utility communication device 100 of FIG. 1 includes a keyboard 108, other input devices may be used, such as a touch screen, stylus, track pad, etc.

Further, although the utility communication device 100 illustrates the keyboard 108 located below the dock 106 in FIG. 1, other implementations are also possible. For example, the keyboard 108 may be disposed above the dock 106 or to a side of the dock 106. In one example, the keyboard 108 is split into multiple sections with different sections located on different sides of the dock. To illustrate, the keyboard 108 may include one section that is located to right side of the dock 106 and another section that is located to a left side of the dock 106. Here, an individual may use fingers of different hands (e.g., thumbs) to input information through the different sections of the keyboard 108. Further, in one example the keyboard 108 is eliminated entirely and an input device (e.g., touch screen, keyboard, etc.) of the cellular device 102 is used in its place.

The main body 104 of the utility communication device 100 may also include other input/output devices. As illustrated in FIG. 1, the main body 104 includes a meter probe port 110 disposed on an exterior of the main body 104 and configured to connect with a utility node device. The meter probe port 110 may comprise any type of port to connect to an optical probe, magnetic/inductive coupler, etc. that obtains a reading from a utility node device. Alternatively, or additionally, the meter probe port 110 may comprise other ports specific to the utility environment. The main body 104 may also include a Universal Serial Bus (USB®) port 112 to connect with other computing devices and a power supply port 114 to receive power. Further, the main body 104 may be equipped with other components discussed in further detail below, such as an antenna, antenna connection port, a scanner, a battery, a camera, a global positioning system, a flashlight, a speaker, a microphone, a vibrator motor, etc.

Meanwhile, the dock 106 may be adapted to removably receive the cellular device 102. In general, the dock 106 may securely retain and/or protect the cellular device 102. The dock 106 may form a protective casing that is adapted to a shape of the cellular device 102. For example, the dock 106 may include one or more retaining members 116 (e.g., 116(1)-116(4)) that securely retain and/or protect the cellular device 102. Additionally, or alternatively, the dock 106 may include one or more shock absorbent protectors 118 (e.g., 118(1)-118(2)) disposed on and extending from one or more corners of the dock 106. Further, the dock 106 may include an opening to provide access (e.g., visible or touch access) to a screen of the cellular device 102 when the cellular device 102 is received in the dock 106.

As noted above, in some instances the main body 104 and the dock 106 are formed to be a single piece (e.g., single enclosure), while in other instances the main body 104 and the dock 106 form separate pieces (e.g., one enclosure to receive the cellular device 102 and one enclosure for the components of the main body 104). In instances where the dock 106 is removable from the main body 104, the dock 106 may be replaced with a different dock adaptable to a different cellular device that exists and/or will be developed in the future, thereby eliminating the need for acquiring a new utility communication device. The main body 104 and/or the dock may be formed of protective materials, such as plastic, aluminum, steel, rubber, composite materials, fiberglass, glass, etc.

The cellular device 102 may be implemented as a computing device, such as a personal computer, a laptop computer, a cellular telephone (e.g., a smart phone), an electronic reader device, a mobile handset, a personal digital assistant (PDA), a portable navigation device, a portable gaming device, a tablet computer, a watch, a portable media player, and so on. The cellular device 102 may be equipped with memory, processor(s), a display (e.g., touch screen), a keypad, a radio (e.g., cellular radio, Wi-Fi® radio, etc.), a speaker, a microphone, a global positioning system, and so on. The cellular device 102 may store and/or implement an operating system and an application(s) by means of the memory and/or the processor(s). In some instances, an application(s) may perform functionality for obtaining utility meter readings, configuring a utility node device, servicing a utility node device, installing a utility node device, and so on.

The memory of the cellular device 102 (and all other memory described herein) may comprise computer-readable media and may take the form of volatile memory, such as random access memory (RAM) and/or non-volatile memory, such as read only memory (ROM) or flash RAM. Computer-readable media includes volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include communication media, such as modulated data signals and carrier waves.

As noted above, the cellular device 102 may include a radio and/or other hardware, firmware, and/or software components to communicate via one or more networks. The one or more networks may include any one or combination of multiple different types of networks, such as cellular networks, wireless networks, Local Area Networks (LANs), Wide Area Networks (WANs), and the Internet.

FIG. 2 illustrates an example of the utility communication device 100 of FIG. 1 with the dock 106 detached from the main body 104. As noted above, in some instances the dock 106 is removably attached to the main body 104 as depicted here. By doing so, the dock 106 may be interchanged with another dock that may be more suitable for a different cellular device (e.g., new or existing cellular devices) that will be received by the utility communication device 100. By using any particular dock from a set of docks, the main body 104 may be adapted for connection with different types and sizes of cellular devices. Such adaptability may reduce costs associated with redesigning and/or manufacturing the utility communication device 100 for use with a different cellular device.

In the example of FIG. 2, the dock 106 includes grooves 200 (e.g., 200(1)-200(3)) that receive matching ridges 202 (e.g., 202(1)-202(3)) of the main body 104. The grooves 200 may be located on a back side of the dock 106 (e.g., a side opposite to the keyboard side). The grooves 200 and ridges 202 may allow the dock 106 to lock onto the main body 104 in a secured manner. Although the example of FIG. 2 attaches the dock 106 to the main body 104 through grooves 200 and ridges 202, it should be appreciated that the dock 106 may be secured in any manner. For example, the dock 106 may alternatively, or additionally, be attached through a clip(s), a latch(es), a cord(s), a screw(s), a bolt(s), a clamp(s), Velcro, an adhesive substance (e.g., glue, tape, etc.), or another fastening and/or securing techniques that are generally known or later developed.

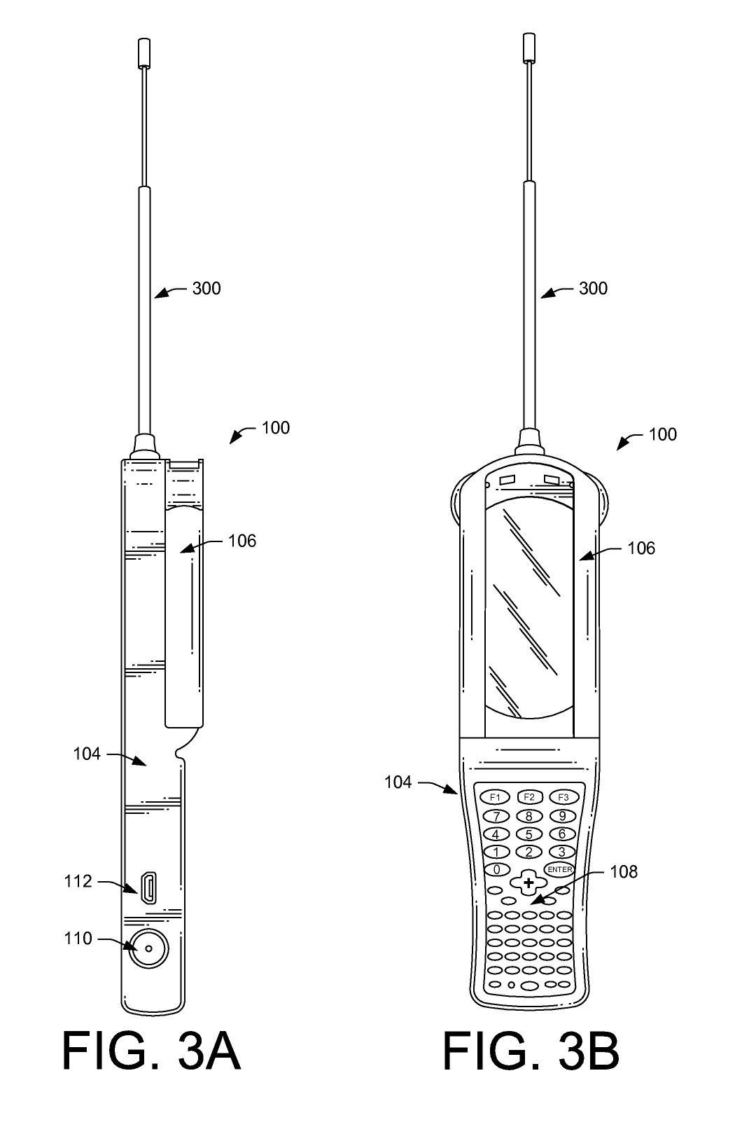

FIG. 3A illustrates an example of a side view of the utility communication device 100 of FIG. 1. As illustrated, a top portion of the main body 104 may be removably attached to an antenna 300 for communicating with a utility node device. The antenna 300 may be connected through an antenna port disposed on a top side of the main body 104, which is connected to a radio that is used for communicating with the utility node device. In some instances, the antenna 300 may comprise a dipole antenna. Although the antenna 300 is illustrated as an external antenna, in some instances the antenna 300 is an internal antenna integrated into one or more of the components of the communication device 100. Further, in some instances the communication device 100 includes an external antenna and an internal antenna, and may include a switch to select between the two antennas. FIG. 3A also illustrates the USB port 112 and the meter probe port 110 (e.g., Hirose port).

FIG. 3B illustrates an example of a front view of the utility communication device 100 of FIG. 1. Here, the keyboard 108 is configured as a customized keyboard that includes buttons for reading, configuring, servicing, and/or installing meters. For example, any of the buttons illustrated as “F1”, “F2”, or “F3” may be associated with functionality for reading, configuring, servicing, and/or installing meters. Other buttons may also be associated with functionality specific to the utility environment. The keyboard 108 of FIG. 3B also includes large numerical buttons for inputting numerical values, such as meter readings.

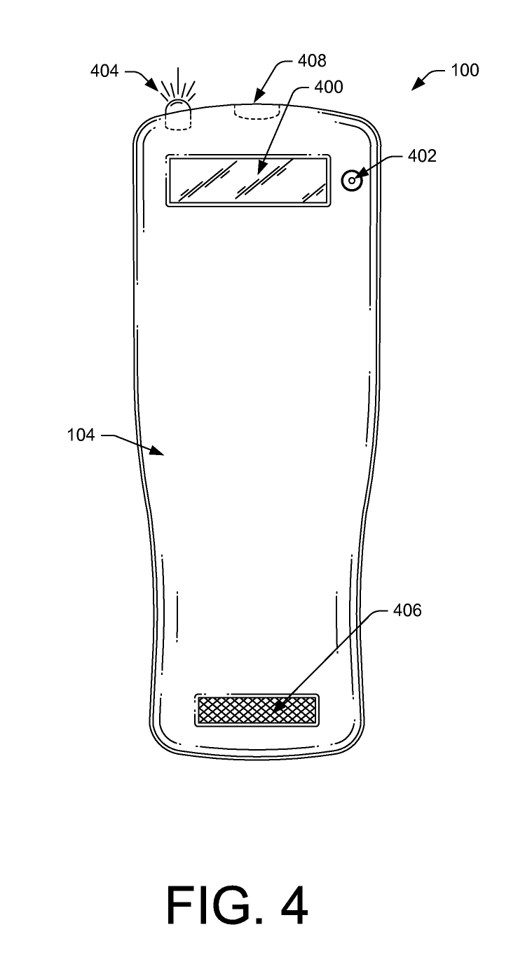

FIG. 4 illustrates an example of a back view of the utility communication device 100 of FIG. 1. Here, the utility communication device 100, in particular the main body 104, is equipped with a scanner 400 to read a bar code (e.g., on a utility node device), a camera 402 (e.g., to take pictures of a meter install, etc.), a flashlight 404, a speaker 406 (e.g., to output information of the cellular device 102), and an antenna port 408 to connect to an antenna.

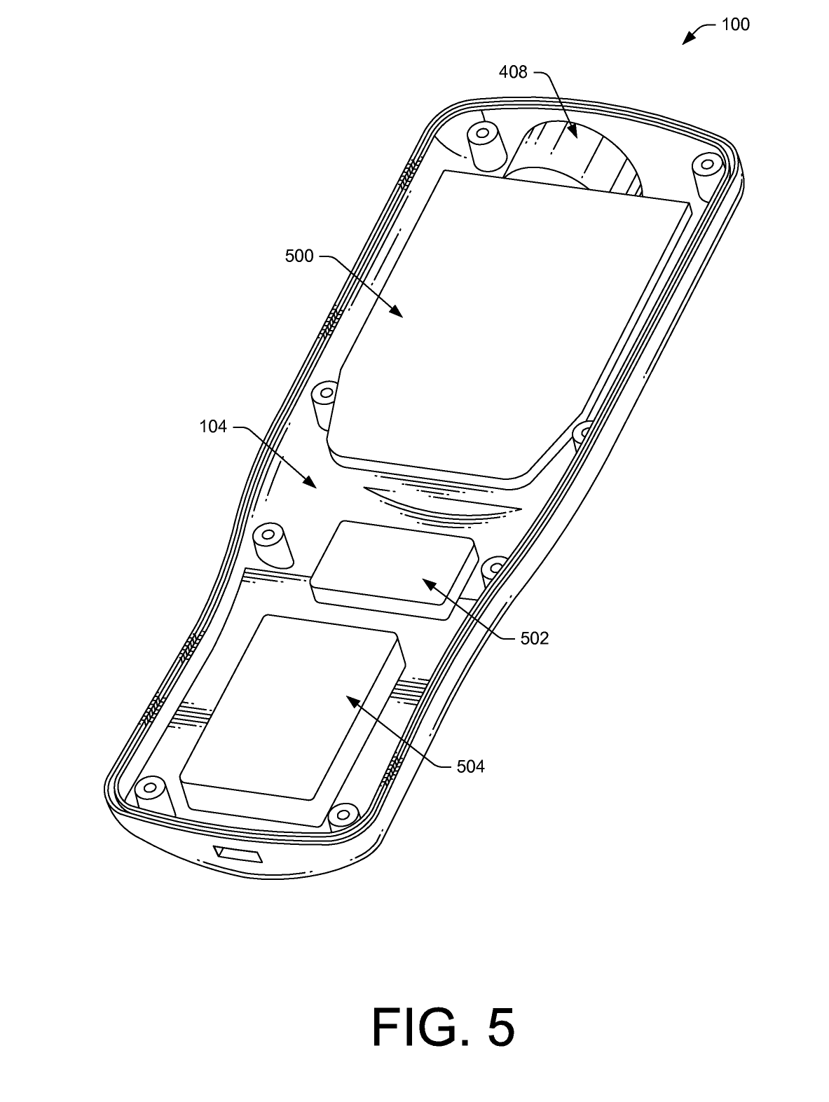

FIG. 5 illustrates an example of an interior of the utility communication device 100 of FIG. 1. Here, clamshell halves of the main body 104 have been separated to expose interior components of the utility communication device 100. As illustrated, the main body 104 includes the antenna port 408 connected to a radio 500 that communicates with a utility node device. The radio 500 may receive and/or send utility information, such as resource consumption information related to consumption of gas, electricity, and/or water (e.g., an amount of resource used), configuring information related configuring a utility node device (e.g., setting parameters, etc.), servicing information related to servicing a utility node device (e.g., errors that have occurred, troubleshooting information, etc.), installation information related to installing a utility node device (e.g., wiring or other connection configurations, testing information, errors due to an install, etc.), and so on.

The main body 104 may also include a communication component 502 (e.g., Bluetooth® module, wired connection, etc.) to communicate with the cellular device 102. The communication component 502 may act as a mediator or interface between the cellular device 102 and the components of the utility communication device 100 (e.g., the radio 500, the keyboard 108, etc.). For example, the communication component 502 may relay utility information and/or other information (e.g., input/output information from the keyboard 108 or ports 110 and 112, etc.) between the components of the utility communication device 100 and the cellular device 102. In one example, the radio 500 receives utility information from a utility node device and forwards the information to the communication component 502 so that the information may be sent to the cellular device 102. In another example, the cellular device 102 sends utility information to the communication component 502 so that the information may be transmitted by the radio 500. In some instances, the radio 500 and the communication component 502 are included on separate electrical boards, components or circuits (as illustrated in FIG. 5), while in other instances the radio 500 and the communication component 502 are included on a same board, component or circuit.

The main body 104 may also include a battery 504 to provide power to the radio 500, the communication component 502, and/or the cellular device 102. In some instances, the battery 504 may be managed to provide power at different times and/or to different components in order to conserve battery life. Further, the main body 104 may include other components, such as a global positioning system, vibrator motor, and so on. In some instances, these components are included on a same electrical board as the radio 500 and/or the communication component 502. Although the radio 500, antenna port 408, communication component 502, and battery 504 are illustrated in particular locations within the main body 104 in FIG. 5, it should be appreciated that these components may be located anywhere within and/or on the main body 104 and/or the dock 106.

As noted above, the utility communication device 100 may utilize the computing resources of the cellular device 102. For example, the utility communication device 100 may utilize the processor, memory, display, operating system, cellular radio, and/or other resources of the cellular device 102. In one example, an application is implemented on the electronic 102 to manage functionality of the cellular device 102 and the utility communication device 100 in order to read, configure, service, and/or install utility node devices.

To illustrate, utility information may be received at the radio 500 and relayed (e.g., sent) to the cellular device 102 through the communication component 502. An application operable on the cellular device 102 may receive the information and use resources of the cellular device 102 to perform one or more actions. For example, the cellular device 102 may display the information on a screen of the cellular device 102, receive input through a touch screen of the cellular device 102 in response to displayed information, process the information, store the information, forward the information (e.g., in raw format or processed) to another computing device (e.g., a central office of a utility), send instructions or information to a utility node through the utility communication device 100, and so on. In one example, the cellular device 102 collects information from one or more utility node devices through the radio 500 and forwards the information to a head end device (e.g., a central office of a utility) through a radio of the cellular device 102 (e.g., cellular radio, Wi-Fi® radio, etc.). Further, in another example the cellular device 102 causes information (e.g., confirmation parameters, information for fixing an error at a utility node device, etc.) to be sent to a utility node device via the radio 500.

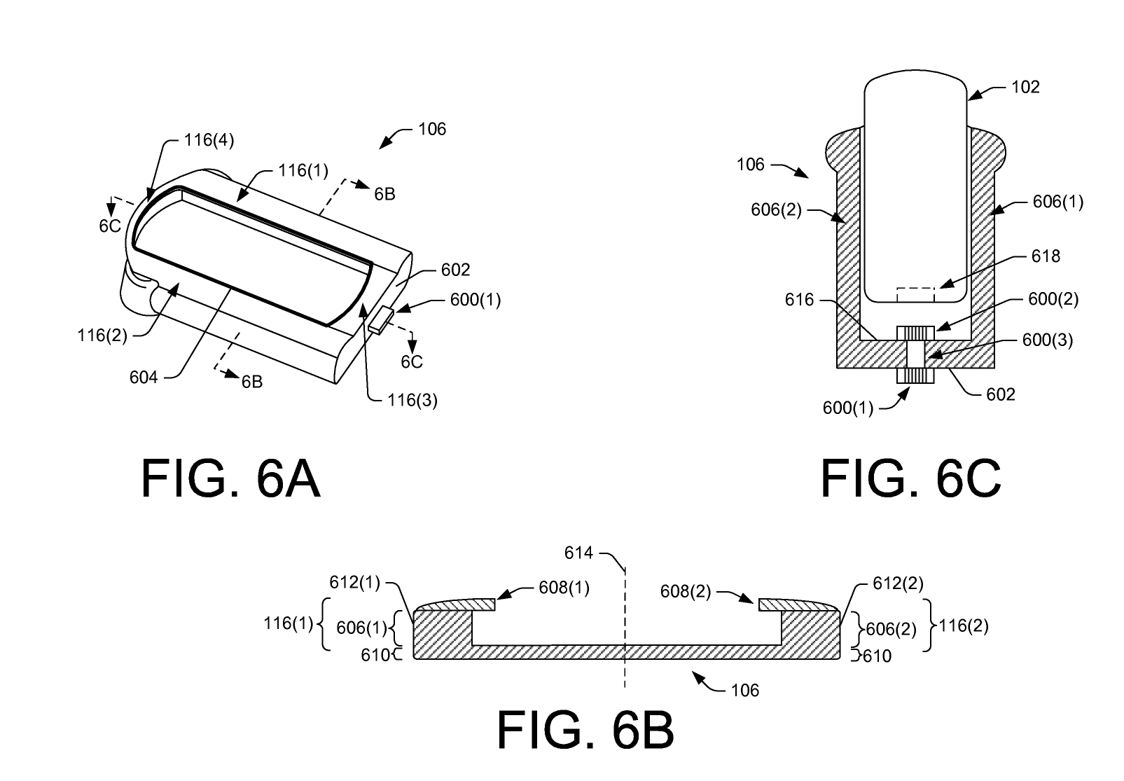

FIGS. 6A-6C illustrate different views of the example dock 106 illustrated in FIG. 1. The dock is representative of docks generally, and each dock may be constructed according to particular dimensions to receive (and typically release) a particular cellular device 102 having associated dimensions. Additionally, docks may be interchangeable, so that a particular main body 104 of a utility communication device 100 may be used with alternative docks. Such interchange facilitates use of alternative cellular devices 102 associated with the alternative docks, respectively. Accordingly, FIG. 6A illustrates a perspective view of the dock 106 sized to receive a particular cellular device 102 (shown in FIG. 1). Here, the dock 106 is illustrated with a connection 600 (e.g., 600(1)-600(3)) to connect with a corresponding connection on the main body 104. The connection 600 may extend through the surface 602 and connect with the cellular device 102 removably received in the dock 106. In some instances, the connection 600 provides a wired connection to the communication component 502 of FIG. 5. Further, the connection 600 may allow power from the battery 504 of FIG. 5 to be provided to the cellular device 102.

FIG. 6A illustrates an opening 604 defined by an edge of the retaining members 116. The opening 604 may provide access to the cellular device 102 received in the dock 106. For example, the opening 604 may allow an individual to view and/or touch a screen of the cellular device 102. In some instances, a transparent material is disposed within the opening 604 to protect a screen of the cellular device 102. The transparent material may comprise a transparent glass, plastic, etc. In some instances, the transparent material may be sealed to the edge of the retaining members 116 to avoid water or other liquid substances penetrating through the opening 604 to the cellular device 102.

FIG. 6B illustrates a cross-sectional top view of the dock 106 taken through a middle portion of the dock 106 (e.g., view from the line labeled “6B” in FIG. 6A). FIG. 6B illustrates the retaining members 116(1) and 116(2) in further detail. For example, the retaining member 116(1) includes a protective wall 606(1) and a tab 608(1). The protective wall 606(1) may be disposed between a base portion 610 of the dock 106 and the tab 608(1). The tab 608(1) may extend from an edge portion 612(1) of the dock 106 toward a middle portion of the dock 106 (illustrated by a line 614) in the horizontal direction of FIG. 6B. Meanwhile, the retaining member 116(2) may include a protective wall 606(2) disposed between the base portion 610 and a tab 608(2). The tab 608(2) may similarly extend from an edge 612(2) toward the middle portion of the dock 106 (illustrated by the line 614). As illustrated, in some instances the protective walls 606(1) and 606(2) may be substantial thick (e.g., horizontal direction of FIG. 6B) in comparison to a height of the base 610 (e.g., vertical direction of FIG. 6B).

In some embodiments, the retaining members 116(3) and/or 116(4) of FIG. 6A may also include a similar structure as that shown with respect to the retaining members 116(1) and 116(2) of FIG. 6B. That is, the retaining members 116(3) and/or 116(4) may include a protective wall and a tab. Alternatively, in some embodiments the retaining members 116(3) and/or 116(4) may merely include a tab that extends over a screen surface of the cellular device 102 from the retaining member 116(1) to the retaining member 116(2) (similar to the structure of the retaining member 116(4) illustrated in FIG. 6A). As such, the retaining members 116 may securely retain and/or provide a protective enclosure for the cellular device 102.

In one embodiment, one or more tabs of the retaining members 116 (e.g., the tabs 608(1) and/or 608(2)) are pivotably attached to respective edge portions of the dock 106 so that the cellular device 102 may be received in the dock 106 through the opening 604. For example, the tab 608(1) may be pivotably attached to the edge portion 612(1) and/or the tab 608(2) may be pivotably attached to the edge portion 612(2). Here, the retaining members 116(3) and/or 116(4) may include protective wall structures.

Further, in one embodiment the retaining members 116 are adjustable to receive cellular devices of different dimensions. For example, the protective walls 606(1) and/or 606(2) may be movable in the horizontal direction of FIG. 6B along the base portion 610 of the dock 106 to secure cellular devices of different widths. Alternatively, or additionally, the tabs 608(1) and/or 608(2) may be movable in the vertical direction of FIG. 6B to secure cellular devices of different thicknesses.

FIG. 6C illustrates a cross-sectional front view of the dock 106 taken through a middle portion of the dock 106 (e.g., view from the line labeled “6C” in FIG. 6A). As noted above, in some instances the dock 106 includes the connection 600 to connect the cellular device 102 with the dock 106 and to connect the dock 106 to the main body 104. The connection 600 may provide power to the cellular device 102 and/or allow communication between the cellular device 102 and the main body 104.

In FIG. 6C, the connection 600 includes a portion 600(1) disposed on the surface 602 to connect the dock 106 to the main body 104. The connection 600 also includes a portion 600(2) disposed on a surface 616 to connect the cellular device 102 to the dock 106. Further, the connection 600 includes a portion 600(3) to connect the portion 600(1) to the portion 600(2). As illustrated in FIG. 6C, the cellular device 102 includes a corresponding connection 618 to connect with the connection 600 (e.g., the portion 600(2)). In some instances, part or all of the connection 600 may be interchanged to adapt to different types of connections used by different cellular devices. For example, the connection 600 may be an adapter removably connected to the dock 106. This may allow a user to use the same dock for different cellular devices and potentially avoid purchasing another dock.

Although one or more of retaining members 116 are illustrated in FIGS. 6A-6C as including a protective wall and a tab to secure the cellular device 102, the retaining members 116 may be implemented in other ways. For example, one or more of the retaining members 116 may be implemented with any desired fastener(s), including: a clip(s), a latch(es), a cord(s), a screw(s), a bolt(s), a clamp(s), Velcro, an adhesive substance (e.g., glue, tape, etc.), or other securing technique(s) that are generally known or developed.

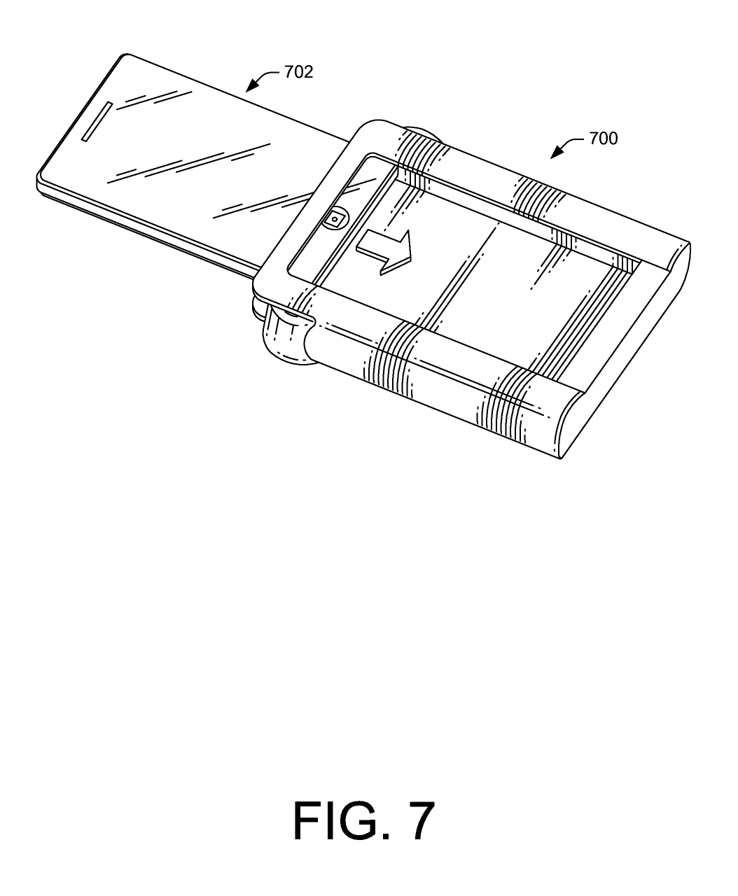

FIG. 7 illustrates an example dock 700 that may be attached to the main body 104 of FIG. 1. As noted above, in some embodiments the main body 104 may be removably attached to docks of different sizes in order to accommodate cellular devices of different sizes. In FIG. 7, the dock 700 is adapted to a size and/or shape of a cellular device 702 so that the main body 104 may receive the cellular device 702. In different examples, different cellular devices 702 are different relative sizes (e.g., height and/or width) in comparison to the cellular device 102 illustrated in FIG. 1.

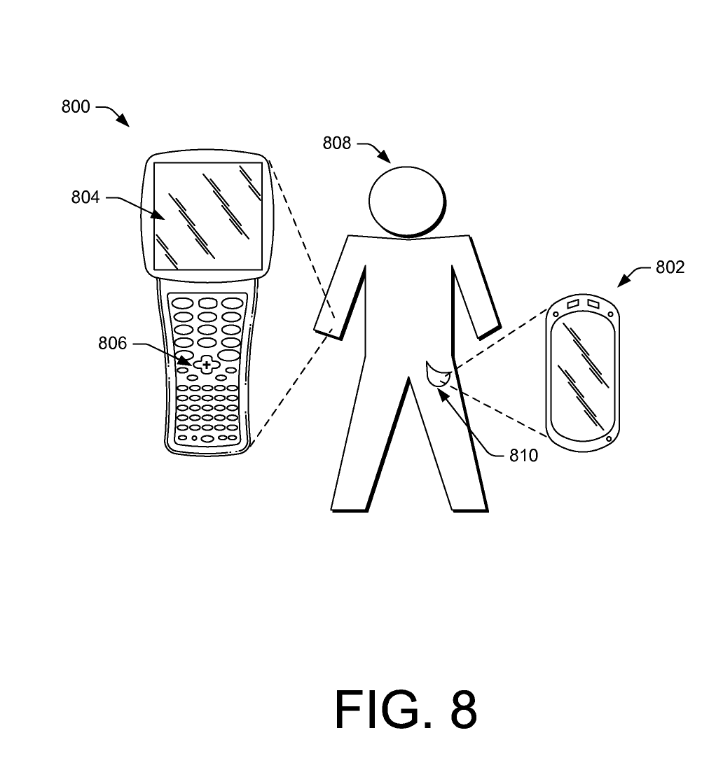

FIG. 8 illustrates an example utility communication device 800 communicatively coupled to a cellular device 802 that is not received in the utility communication device 800. That is, radio communication between the utility communication device 800 and cellular device 802, and/or availability of a display screen 804 on the communication device, obviate the need for a dock and/or direct physical connection between the two. Here, the utility communication device 800 may include basic functionality to communicate with a utility node (e.g., by operation of a specialized radio) and to communicate with the cellular device 802 (e.g., using Bluetooth® radio). The utility communication device 800 may also include a display screen 804 (e.g., touch screen) and a keyboard 806 to interface with an individual 808. Additionally, the utility communication device 800 may include any other components discussed above in reference to the utility communication device 100. The components of the utility communication device 800 may be located within an enclosure to protect the components.

The example utility communication device 800 of FIG. 8 may be configured to wirelessly communicate with the cellular device 802 in order to utilize resources of the cellular device 802. In one example, the wireless connection is enabled when the utility communication device 800 and the cellular device 802 are in close proximity (e.g., located in a same room, on a person, within a predetermined proximity), such as in the case of a Bluetooth® connection. As illustrated in FIG. 8, the cellular device 802 is located within a pocket 810 of the individual 808, while the utility communication device 800 is held by the individual 808.

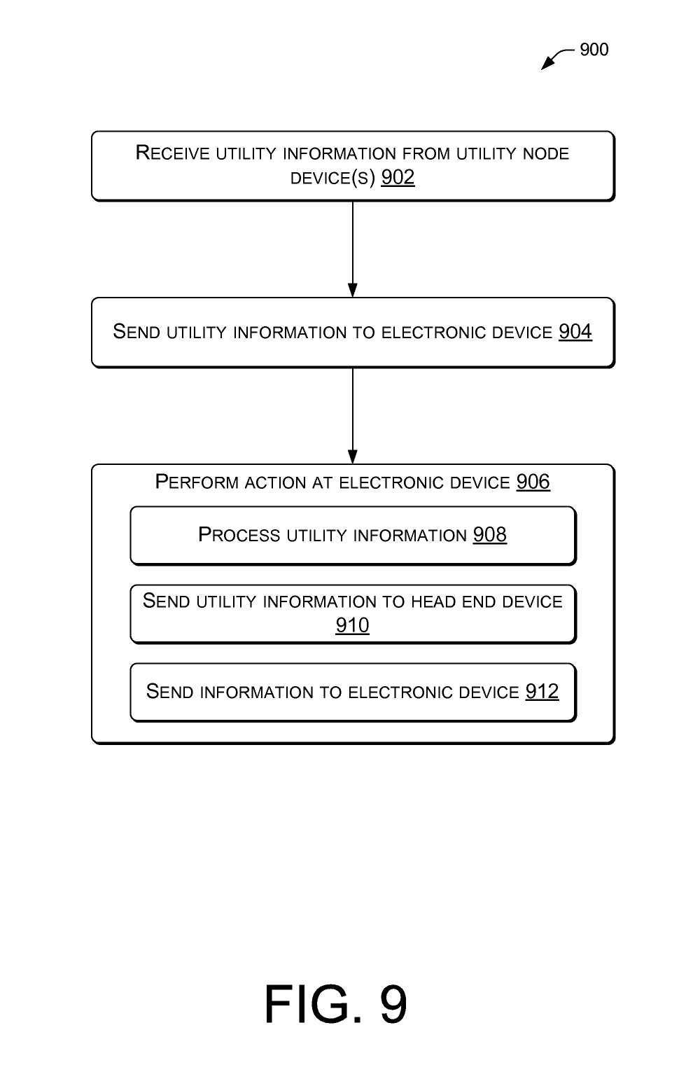

FIG. 9 illustrates an example process 900 for employing the techniques described herein. For ease of illustration process 900 is described as being performed by the utility communication device 100 and/or the cellular device 102 of FIG. 1. However, process 900 may be performed by other devices and the utility communication device 100 and/or cellular device 102 may be used to perform other processes.

The process 900 (as well as each process described herein) is illustrated as a logical flow graph, each operation of which represents a sequence of operations that can be implemented in hardware, software, or a combination thereof In the context of software, the operations represent computer-executable instructions stored on one or more computer-readable storage media that, when executed by one or more processors, perform the recited operations. In the context of hardware, the operations may represent logic configured for operation within one or more devices (e.g., application specific integrated circuits (ASICs), gate arrays and/or programmable logic devices. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In some embodiments, the example process 900 may be performed in the context of reading utility information from one or more utility node devices. In this example, the communication device 100 may be located within a predetermined proximity to the one or more utility node devices. For instance, the utility communication device 100 may be passing along a street and a utility node device may be located at a residence along the street. As such, in one example, the one or more utility node devices are configured for automatic meter reading (AMR).

At an operation 902, the utility communication device 100 may receive utility information from one or more utility node devices. The utility information may be received through a radio of the communication device that is configured to communicate according to a particular standard that is utilized by the one or more utility node devices. The utility information may include resource consumption information, configuration information, servicing information, and/or installation information.

At an operation 904, the utility communication device 100 may send the utility information to the cellular device 102. In particular, the communication component of the utility communication device 100 may send the information to the cellular device 102. The utility information may be sent over a wireless and/or wired connection (e.g., Bluetooth®, wired connector, etc.). In some instances, the cellular device 102 is (at least temporarily) connected to the utility communication device 100, while in other instances the cellular device 102 is located within a predetermined distance to the utility communication device 100.

At an operation 906, the cellular device 102 may perform one or more actions, examples of which are seen at operations 908-912. In some implementations, the cellular device 102 is a cell phone, and the actions may be performed by one or more applications running on the cell phone. For example, at an operation 908 the cellular device 102 may process the utility information. In a few examples, the operation 908 may include collecting utility information from multiple utility node devices, formatting the utility information for storage and/or transmission, and/or utilizing the utility information in one or more applications designed for collecting resource consumption information, configuring utility node devices, servicing utility node devices, and/or installing utility node devices.

Alternatively or additionally, at an operation 910 the cellular device 102 may send the utility information to a head end device of utility (e.g., central office). The utility information may be sent according to a different modulation technique, protocol and/or at a different frequency than that utilized by the utility communication device 100. For example, the utility information may be sent according to a generally known cellular technology, Wi-Fi®, etc.

Alternatively or additionally, data, instructions and/or information may be sent by the head office to the cellular device 102, for transmission to the utility communication device 100, for communication to one or more utility nodes, etc. In the example operation 912, the cellular device 102 may send information to the utility communication device 100. The utility communication device 100 may then send the information to the one or more utility node devices. In one example, upon processing the utility information at the operation 908, the cellular device 102 may determine that information needs to be sent back to a particular utility node device to configure the particular utility node device. In this example, the cellular device 102 may send configuration information to the utility communication device 100 which would then relay the information to the particular utility node device.

As noted above, the example process 900 is described as being performed by the utility communication device 100 and/or the cellular device 102. It should be appreciated that these devices may perform other processes. In one example, information (e.g., a disconnect command) is sent from a head end device (e.g., central office) to the cellular device 102 and then to the utility communication device 100. The communication device 100 may then send a message to a utility node device to cause the utility node device to perform an action, such as disconnecting gas, water, and/or electricity service at the utility node device.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A utility node communication device comprising:
a dock to removably receive a cellular device, the dock having retaining members to securely retain the cellular device within the dock, the retaining members defining an opening to provide access to a display screen of the cellular device; and
a main body attached to the dock, the main body comprising:
a radio to communicate utility information with a utility node device;
a communication component communicatively coupled to the radio, the communication component to communicate with the cellular device; and
a keyboard to receive input from an individual and to send keystroke information based on the input to the communication component or the radio.

2. The utility node communication device of claim 1, wherein the cellular device comprises a cellular telephone, an electronic reader device, a personal digital assistant (PDA), and/or a tablet computer.

3. The utility node communication device of claim 1, wherein the utility information comprises:
resource consumption information related to consumption of gas, electricity, and/or water;
configuration information related configuring the utility node device;
servicing information related to servicing the utility node device; and/or
installation information related to installing the utility node device.

4. The utility node communication device of claim 1, further comprising the cellular device connected to the dock.

5. The utility node communication device of claim 1, wherein the main body further comprises a meter probe port to connect to a probe that obtains a reading from the utility node device.

6. The utility node communication device of claim 1, wherein the main body and the dock are releasably attached to each other.

7. The utility node communication device of claim 1, wherein the dock and the main body form a single piece.

8. The utility node communication device of claim 1, wherein the dock includes shock absorbent protectors.

9. The utility node communication device of claim 1, wherein each retaining member includes a protective wall and a tab, the protective wall being disposed between the tab and a base portion of the dock, the tab extending from an edge portion of the dock toward a middle portion of the dock.

10. A utility node communication device comprising:
a radio to communicate with a utility node device; and
a communication component communicatively coupled to the radio, the communication component to communicate with a cellular device located proximately to the utility node communication device.

11. The utility node communication device of claim 10, wherein the radio communicates according to a protocol adapted for utility reading.

12. The utility node communication device of claim 10, wherein the utility node communication device comprises a display screen and/or a keyboard.

13. The utility node communication device of claim 10, wherein the communication component is communicatively coupled to the cellular device through a wireless connection.

14. The utility node communication device of claim 10, further comprising:
an enclosure to house the radio and the communication component, the enclosure providing a protective casing for the radio and the communication component.

15. The utility node communication device of claim 14, further comprising:
a dock attached to the enclosure,
wherein the dock is configured to connect to the cellular device and to release the cellular device.

16. The utility node communication device of claim 15, wherein the dock forms a protective casing for the cellular device and is adapted to a shape of the cellular device.

17. The utility node communication device of claim 10, further comprising:
a battery to provide power to the radio, the communication component, and/or the cellular device.

18. A method implemented at least in part by a utility node communication device, comprising:
receiving, at the utility node communication device, utility information from a proximate utility node device, the utility information comprising resource consumption information related to consumption of gas, electricity, and/or water, configuration information related configuring the proximate utility node device, servicing information related to servicing the proximate utility node device, and/or installation information related to installing the proximate utility node device; and
sending, by the utility node communication device, the utility information to a cellular device communicatively coupled to the utility node communication device, the cellular device comprising a cellular telephone, an electronic reader device, a personal digital assistant (PDA), and/or a tablet computer.

19. The method of claim 18, further comprising:
performing an action by the cellular device, the action comprising:
processing the utility information,
storing the utility information,
sending the utility information to a head end device of a utility, and/or
sending information to the utility node communication device to be sent to the proximate utility node device.

20. The method of claim 18, wherein the receiving includes receiving the utility information according to a protocol adapted for utility reading.
